(19) United States
(12) Patent Application Publication
(10) Pub. No.: US 2016/0004225 A1
(43) Pub. Date: Jan. 7, 2016

(54) METHOD AND PROTECTION DEVICE FOR PROTECTING AN ELECTRIC MOTOR AND/OR AN OPERATING MACHINE WHICH IS COUPLED THERETO FROM INCORRECT CONTROL OPERATIONS

(71) Applicant: KRIWAN Industrie-Elektronik GmbH, Forchtenberg (DE)

(72) Inventor: Christian Ellwein, Schwäbisch Hall (DE)

(21) Appl. No.: 14/747,263

(22) Filed: Jun. 23, 2015

(30) Foreign Application Priority Data
Jul. 2, 2014 (DE) 10 2014 109 279.1

(51) Int. Cl. G05B 9/02

(52) U.S. Cl. CPC G05B 9/02

(57) ABSTRACT

A method for protection of an electric motor and/or operating machine coupled thereto from incorrect control operations detects the number of incorrect control operations of the electric motor and/or the operating machine in accordance with first and second error criterions. The numbers are totalled, and an alarm signal is produced and/or the electric motor is switched into a predefined state when the total exceeds a predetermined limit. A protection device for protecting an electric motor and/or an operating machine coupled thereto from incorrect control operations is also disclosed for carrying out the method.

### CROSS-REFERENCE TO RELATED APPLICATIONS

This application claims the benefit of German Patent Application No. 10 2014 109 279.1, filed Jul. 2, 2014, and incorporated herein by reference.

### TECHNICAL FIELD

The invention relates to a method and a protection device for protecting an electric motor and/or an operating machine which is coupled thereto from incorrect control operations.

### BACKGROUND OF THE INVENTION

Electric motors are used in many applications, sometimes also in applications with a critical infrastructure, such as, for example, in pumps of the water supply or in cooling processes in power stations. In a world which is networked to an increasingly great extent by means of network technology, computer and IT, industrial applications may also be subjected to attacks by hackers, viruses and malware. This problem has been intensified in recent years in particular by proprietary or isolated field buses and control and guidance systems being replaced and supplemented by TCP/IP-based networks (Industrial Ethernet). In many cases, control units, regulators, frequency converters and other control units for electric motors thereby have an Internet connection. These control and regulation devices for controlling electric motors are nowadays almost completely microprocessor-based, Linux often being used as an operating system, and have freely programmable stores and are consequently technically accessible to malware. A further known example is the malware “Stuxnet” by means of which centrifuges in Iran have been mechanically damaged.

It is known that the protection from malware can never be 100%. New problems will arise again and again as a result of newly discovered security loopholes in standard programs. It should be assumed that a similar problem also arises with the networking of machines and installations by there being introduced on a PLC, a frequency converter or a regulator potentially critical malware which is not yet identified by the current protection software.

In the field of office work, the requirement for protection is substantially limited to data, the integrity, the confidentiality and the availability of the data being intended to be ensured. In the event of damage, it is in most cases possible to limit a significant portion of the damage by means of reinstallation of the system and a reconstruction of the data from a backup. In the ICS field (Industrial Control Systems), it is different: in this instance, machines can sometimes be damaged beyond repair by means of malware. This results, on the one hand, in the affected component having to be replaced and, on the other hand, in the process which is influenced by the component being disrupted to a great extent. Particularly critical in this instance are electric motors which are used in a large number of components and which can be damaged by means of incorrect control. The operating machines which are also coupled to the electric motor, such as pumps, compressors or access systems (doors, gates, ramps) are correspondingly endangered. Electric motors are already currently protected by means of motor protection relays and motor protection switches. To this end, the electric current consumption of the motor and/or the winding temperature are measured as significant parameters and compared with limit values (EP 1 967 831 B1).

DE 34 43 276 A1 (U.S. Pat. No. 4,525,763) relates to a device and a method for protection of motors and for predicting the motor service-life using the temperature and the elapsed operating time of the motor. In this instance, model devices which are connected to the motor are provided for monitoring the temperature of the motor windings and for producing an error rate for the motor in accordance with the temperature of the windings thereof. The error rate is integrated by an integrator in order to produce an error occurrence for the motor, a logical actuation or rapid shut-off circuit which is connected to the integrator receiving the error occurrence and producing an actuation or shut-off signal in accordance therewith.

### SUMMARY OF THE INVENTION

An object of the invention was now to provide a method and a protection device for protection of an electric motor and/or an operating machine which is coupled thereto from incorrect control operations, which is distinguished by means of a high level of efficiency and which ensures effective protection of the electric motor and/or the operating machine which is coupled thereto.

This object is achieved according to the invention by the features of claims 1 and 6. Advantageous embodiments of the invention are set out in the additional claims.

In the method according to the invention for protection of an electric motor and/or an operating machine which is coupled thereto from incorrect control operations, the number of incorrect control operations of the electric motor and/or the operating machine is detected in accordance with a first error criterion and the number of incorrect control operations of the electric motor and/or the operating machine is detected in accordance with a second error criterion and totalled. In this instance, an alarm signal is produced and/or the electric motor is switched into a predefined state when the total of the incorrect control operations detected exceeds a predetermined limit.

The protection device according to the invention for protecting an electric motor and/or an operating machine which is coupled thereto from incorrect control operations substantially provides the following components: a first detection unit for incorrect control operations of the electric motor and/or the operating machine in accordance with a first error criterion, at least a second detection unit for incorrect control operations of the electric motor and/or the operating machine in accordance with a second error criterion, a totalling member for totalling the number of incorrect control operations and an actuation unit for producing an alarm signal and/or for switching the electric motor into a predefined state when the total of the incorrect control operations detected exceeds a predetermined limit.

The invention which is set out here describes a motor protection system which measures additional physical parameters beyond the prior art in order to identify a critical control of the motor. Since electric motors are very well understood in terms physics and the operating method of conventional motor protection circuits and their desired ranges are known or can be very rapidly established by means of simple tests, it would be readily possible to control the electric motor and/or the operating machine in such a manner that the individual error criteria still do not actuate any alarm, but the total of at least two different incorrect control operations can lead to damage of the electric motor and/or the operating machines which are coupled thereto.

In contrast to conventional virus protection programs, which identify malware by means of virus scanners, firewalls, encryptions and other measures and prevent their access, the present invention assumes that the electric motor and/or the operating machine is controlled by a malicious code. By totalling incorrect control operations of at least two different error criteria, a critical state can also be identified when the electric motor and/or the operating machine is still in the desired range with respect to a specific error criterion.

By measuring at least two different physical variables or parameters on the electric motor and/or the operating machine or the control thereof, statuses which can readily lead to the destruction thereof are identified.

Depending on the type of the individual error criteria, it may be advantageous to weight them differently in the totalling of the incorrect control operations. If the electric motor or the operating machines which are coupled thereto are controlled by means of a network, the protective device should preferably be arranged so as to be separated from the network so that the detection of the incorrect control operations in accordance with the different error criteria, the totalling of the number of incorrect control operations and the actuation of an alarm signal or the transfer of the electric motor to a predefined state cannot be influenced by any malware.

As a result of the good knowledge of electric motors and the operating machines which are coupled thereto, the most important possibilities which a potential attacker has of destroying a motor can be relatively simply described in error criteria. These error criteria are stored in the protection device and monitored constantly. If the total of the incorrect control operations detected exceeds a predetermined limit, the protection device may either switch off the electric motor or bring it into a predefined safe state. Such a state with a pump for cooling medium may, for example, be the maximum output. Consequently, although under some circumstances more energy is consumed than is required, there is in any case adequate cooling.

The parameters which can be monitored can be divided, on the one hand, into parameters which describe the electric motor and the protection thereof and, on the other hand, into parameters which describe the operating machine which is coupled to the electric motor. In this instance, it is possible to detect and take into account in particular at least one of the error criteria of the electric motor and/or the operating machine set out below: unauthorised switching frequency, unauthorised maximum and/or minimum switching-on durations, unauthorised change of speed, unauthorised change of the rotation direction, inadmissibly high motor current in a coil of the electric motor, unauthorised frequency of the motor current, unauthorised motor voltage over the frequency, unauthorised motor current over the frequency, unauthorised oscillations in the electric motor and/or the operating machine, erroneous process parameters in the operating machine.

A programmer of malware for a frequency converter could select two or more error criteria in parallel in order to critically control and destroy a motor. It is, for example, possible to alternately set the motor current to be excessively high and to change the rotation direction in an excessively rapid manner. Selective damage of the motor will, however, always take place within a finitely short period of time. For this reason, each time one of these error criteria is exceeded, a common counter in the protection module is increased, regardless of which rule has been exceeded. When this counter exceeds a defined limit value within a specific time unit, the protection device emits an alarm signal and/or the electric motor switches into a predefined safe state. As a result of totalling, the number of error alarms (warning of manipulation, but in reality there is only a “normal” brief overload of the motor) is also prevented from becoming excessively high.

Other embodiments of the invention are explained in greater detail below with reference to the description of an embodiment.

### BRIEF DESCRIPTION OF THE DRAWINGS

FIG. 1 is a block diagram of an installation having an electric motor, an operating machine which is coupled thereto and a protection device.

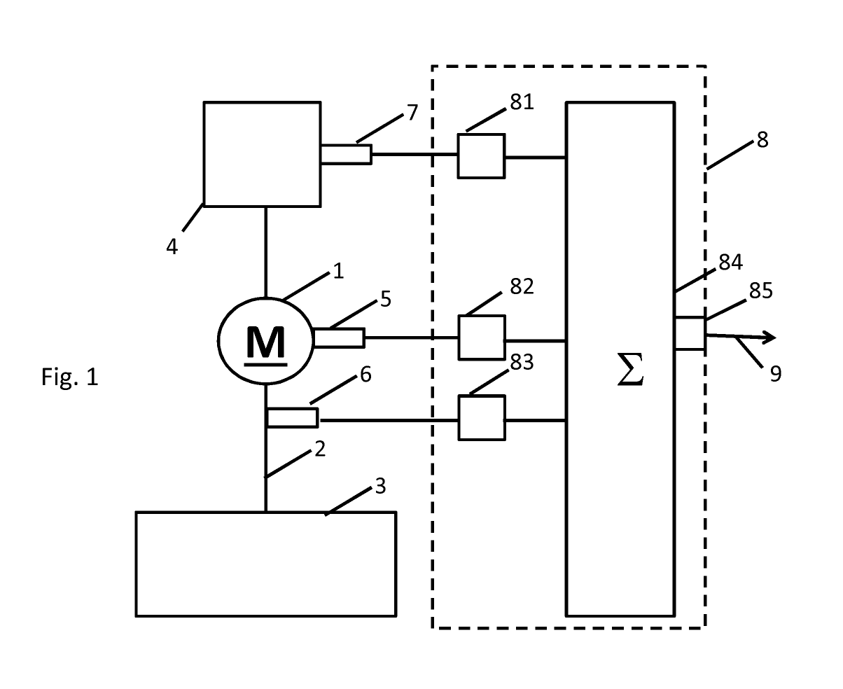

### DETAILED DESCRIPTION OF ILLUSTRATIVE EMBODIMENTS

An electric motor 1 is connected to a control device 3 (frequency converter, regulator, PLC or the like) by means of an electrical connection 2 and mechanically connected to an operating machine 4. The operating machine 4 may, for example, be a compressor of a cooling circuit.

A protection device comprises at least a first detection unit 5, a second detection unit 6 and a third detection unit 7 which each detect status variables of the electric motor 1, the control of the electric motor or the operating machine 4, which are connected with potential damage of the electric motor or the operating machine. The following status variables may, for example, be detected: switching frequency of the motor, maximum and/or minimum switching-on period, speed, rotation direction, motor current in a winding of the electric motor, frequency of the motor current, motor voltage over the frequency, motor current over the frequency, oscillations in the electric motor and/or the operating machine, process parameters in the operating machine. However, the list is in no way intended to be considered to be definitive. Depending on the electric motor or operating machine, additional or other status variables can also be measured and evaluated.

The protection device further comprises an electronic evaluation unit 8, the status variables measured in the detection units 5, 6 and 7 being evaluated together and combined taking into account an individual weighting factor 81, 82, 83 in a common totalling member 84. In this instance, the measured status variables are compared with predetermined desired values. If the desired value is exceeded, this is categorised as an incorrect control operation, with all the incorrect control operations of the detection units 5, 6 and 7 being totalled in the totalling member 84, optionally with an individual weighting factor.

If, within a predefined period of time, an excessively high number of incorrect control operations is detected by the detection units, there is produced by means of an actuation device 85 an output signal 9 which indicates a possible manipulation of the control device 3. This output signal 9 may be an alarm signal. With this output signal 9, however, the electric motor could also be switched into a predefined state. The totalling of the incorrect control operations over a predefined period of time also has the advantage that an output signal 9 is not already produced in the event of a desired value being exceeded only once.

1. A method for protection of an electric motor and/or an operating machine which is coupled thereto from incorrect control operations, wherein the number of incorrect control operations of the electric motor and/or the operating machine is detected in accordance with a first error criterion and the number of incorrect control operations of the electric motor and/or the operating machine is detected in accordance with a second error criterion and totalled, wherein an alarm signal is produced and/or the electric motor is switched into a predefined state when the total of the incorrect control operations detected exceeds a predetermined limit.

2. The method according to claim 1, characterised in that the error criteria are weighted differently when the incorrect control operations are totalled.

3. The method according to claim 2, characterised in that at least one of the error criteria of the electric motor and/or the operating machine set out below is/are detected and taken into account: unauthorised switching frequency, unauthorised maximum and/or minimum switching-on durations, unauthorised change of speed, unauthorised change of the rotation direction, inadmissibly high motor current in a coil of the electric motor, unauthorised frequency of the motor current, unauthorised motor voltage over the frequency, unauthorised motor current over the frequency, unauthorised oscillations in the electric motor and/or the operating machine, erroneous process parameters in the operating machine.

4. The method according to claim 1, characterised in that at least one of the error criteria of the electric motor and/or the operating machine set out below is/are detected and taken into account: unauthorised switching frequency, unauthorised maximum and/or minimum switching-on durations, unauthorised change of speed, unauthorised change of the rotation direction, inadmissibly high motor current in a coil of the electric motor, unauthorised frequency of the motor current, unauthorised motor voltage over the frequency, unauthorised motor current over the frequency, unauthorised oscillations in the electric motor and/or the operating machine, erroneous process parameters in the operating machine.

5. The method according to claim 1, characterised in that the alarm signal is produced and/or the electric motor is switched to a predefined state only when the total of the incorrect control operations detected within a predetermined period of time exceeds a predetermined limit.

6. The method according to claim 2, characterised in that the alarm signal is produced and/or the electric motor is switched to a predefined state only when the total of the incorrect control operations detected within a predetermined period of time exceeds a predetermined limit.

7. The method according to claim 3, characterised in that the alarm signal is produced and/or the electric motor is switched to a predefined state only when the total of the incorrect control operations detected within a predetermined period of time exceeds a predetermined limit.

8. The method according to claim 4, characterised in that the alarm signal is produced and/or the electric motor is switched to a predefined state only when the total of the incorrect control operations detected within a predetermined period of time exceeds a predetermined limit.

9. The method according to claim 1, characterised in that the electric motor is controlled by means of a network and the detection of the incorrect control operations, the totalling of the number of incorrect control operations and the production of the alarm signal and/or the switching of the electric motor into a predefined state when the total of the incorrect control operations detected exceeds a predetermined limit are carried out without connection to the network.

10. The method according to claim 2, characterised in that the electric motor is controlled by means of a network and the detection of the incorrect control operations, the totalling of the number of incorrect control operations and the production of the alarm signal and/or the switching of the electric motor into a predefined state when the total of the incorrect control operations detected exceeds a predetermined limit are carried out without connection to the network.

11. The method according to claim 3, characterised in that the electric motor is controlled by means of a network and the detection of the incorrect control operations, the totalling of the number of incorrect control operations and the production of the alarm signal and/or the switching of the electric motor into a predefined state when the total of the incorrect control operations detected exceeds a predetermined limit are carried out without connection to the network.

12. The method according to claim 4, characterised in that the electric motor is controlled by means of a network and the detection of the incorrect control operations, the totalling of the number of incorrect control operations and the production of the alarm signal and/or the switching of the electric motor into a predefined state when the total of the incorrect control operations detected exceeds a predetermined limit are carried out without connection to the network.

13. The method according to claim 5, characterised in that the electric motor is controlled by means of a network and the detection of the incorrect control operations, the totalling of the number of incorrect control operations and the production of the alarm signal and/or the switching of the electric motor into a predefined state when the total of the incorrect control operations detected exceeds a predetermined limit are carried out without connection to the network.

14. A protection device for protecting an electric motor and/or an operating machine which is coupled thereto from incorrect control operations having
a first detection unit for incorrect control operations of the electric motor and/or the operating machine in accordance with a first error criterion,
at least a second detection unit for incorrect control operations of the electric motor and/or the operating machine in accordance with a second error criterion,
a totalling member for totalling the number of incorrect control operations and
an actuation unit for producing an alarm signal and/or for switching the electric motor into a predefined state when the total of the incorrect control operations detected exceeds a predetermined limit.

15. The protection device according to claim 14, characterised in that the electric motor is connected via a network for control and the protection device is arranged so as to be separated from the network.
